(19) United States
(12) Patent Application Publication
(10) Pub. No.: US 2009/0262622 A1
(43) Pub. Date: Oct. 22, 2009

(54) Integrated Standalone Optical Disc Duplication And Labeling System Capable Of Recording Information On The Data Side And Printing Images By Direct Laser Labeling On The Opposite Side Optical Disc

(76) Inventors: Shuo Wei Chang, Alhambra, CA (US); Chia Chun Cheng, Alhambra, CA (US)

Correspondence Address: LAW OFFICES OF J.F. LEE, 17800 CASTLETON STREET, SUITE 383, CITY OF INDUSTRY, CA, 91748, US

(21) Appl. No.: 12/105,653

(22) Filed: Apr. 18, 2008

(51) Int. Cl. G11B 7/28

(52) U.S. Cl. 369/84

(57) ABSTRACT

Present invention provides a one-stop simplified mechanism of optical disc duplication and labeling, all done within the same integrated standalone system, saving the trouble of multi-step disc handling and the saving the cost of additional expenses related to the use of traditional labeling method such as ink, ribbons and other consumable items.

### FIELD OF THE INVENTION

The present invention relates to an integrated disc duplication system and labeling system, so that users of disc duplication need not take a second step to have the newly duplicated discs labeled by a separate system, but instead obtain the duplicated disc, with desired labeling, done in the same machine.

### BACKGROUND OF THE INVENTION

The optical disc, including the format of CD and DVD, has been a popular data storage and exchange media of today due to the increasing desire for large capacity storage media. The evolving blu-ray and HD DVD discs follow the trend with several times higher capacity compared to the CD and DVD. The boom for disc duplication and labeling is correlated to the high demand for optical discs.

In the prior art, a recorder is dedicated to record the information onto the data side of the optical disc, and the duplication can be accomplished by a PC, a manual tower, or an autoloader. The labeling, on the other hand, may be diversified to several approaches. The easiest approach is to manually write on the disc with a pen or marker. But the labeling is limited to simple context and large volume labeling in a timely basis is almost impossible.

The second approach is to use a printing system, which allows a user to label complex graphics or even photos on the disc in addition to pure text. The printing methods may vary and options include thermal printers, inkjet printers, silk screen machine, etc. Despite the availability of multiple choices, this prior art has several drawbacks. Acquiring a printing system inevitably results in higher initial costs. Second, the printing systems always require some consumable materials. For example, the inkjet printer consumes ink or ink cartridges and the thermal printer uses ribbons, which need frequent refills and/or maintenance. All these accessories add to the subsequent cost of a project as the production moves forward.

The direct laser labeling technology, however, illustrated in U.S. Pat. No. 7,088,380 to Bronson et al. and U.S. Pat. No. 7,224,646 to Morishima et al., has advantages over the traditional said labeling methods in that there is no consumable materials involved. Instead, the label side of the optical disc is directly exposed to the laser beam emitted from the disc drive and the label is formed by the reaction of the label side and the laser beam. The said invention is now made possible by properly stacking and controlling several compound devices capable of both recording data and labeling images.

### OBJECTS AND SUMMARY OF THE INVENTION

A standalone integrated system comprises a controller and multiple optical disc drives capable of recording data and forming images by means of direct laser labeling. The controller completes the duplication by reading from the source and writing the information to the data side of multiple optical discs. The controller completes the labeling by reading the label symbol from the source and forming images on the label side of multiple optical discs. The source data and source label symbol may come directly from a personal computer connected to said system through a specific communication channel, such as USB, firewire, or network to name a few. Or the source data can be saved on a storage medium, such as an optical disc or a memory card just to name a few, which can be mounted on said system.

### BRIEF DESCRIPTION OF THE DRAWINGS

FIG. 1 illustrates an embodiment of the invention.

FIG. 2 is a flowchart of duplication process.

FIG. 3 is a flowchart of labeling process.

### DETAILED DESCRIPTION OF THE PREFERRED EMBODIMENT

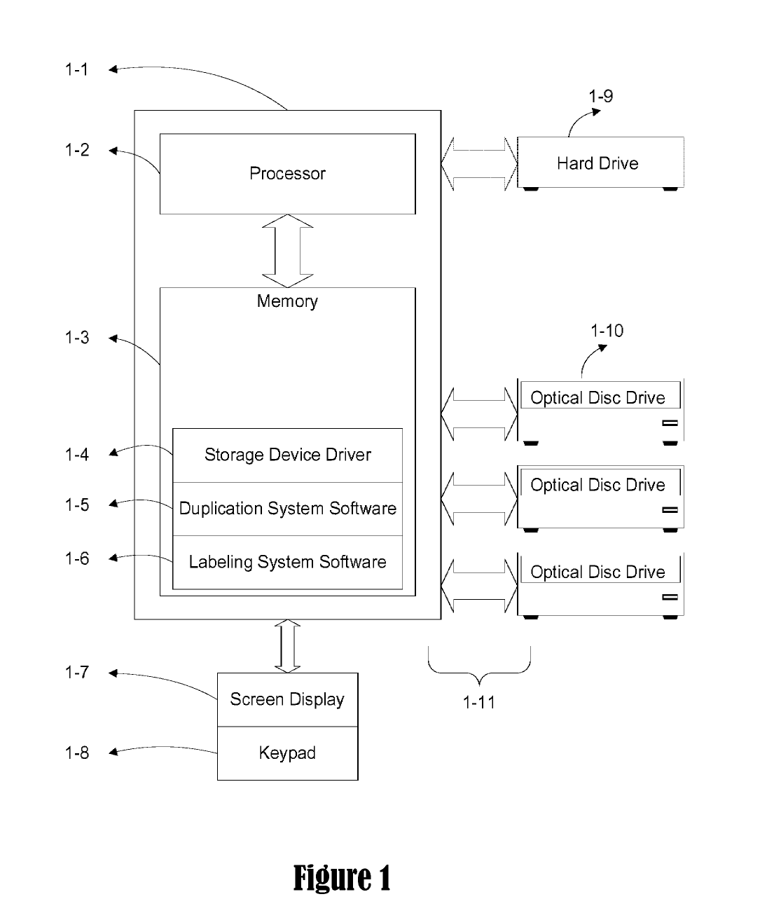

FIG. 1 is a schematic illustration according to one embodiment of the invention. A standalone duplication and labeling system comprise a set of optical disc drives 1-10, a central controller 1-1, a keypad 1-8, and a LCD screen 1-7. The optical disc drives 1-10 are connected to the central controller 1-1, and the connection 1-11 in between follows the PATA/SATA with Packet Interface standards. An optional hard drive 1-9 may connect to the central controller following the same standards as an additional storage device.

The optical disc drive 1-10 accepts multiple types of optical discs including but not limited to CD and DVD. The optical disc drive is capable of emitting a laser beam to burn data on the data side or form symbol on the label side of the optical disc.

The central controller is responsible for communicating with storage devices 1-9 and 1-10, controlling the duplication and labeling process, and interacting with the end user through an output display 1-7 and an input keypad 1-8. The central controller includes a processor 1-2 and a memory 1-3. The processor 1-2 may be any kind of general purpose processor and executes the programmed firmware or software. The memory 1-3 can be any kind of digital memory and may store, among other things, the storage device driver 1-4, the duplication system software 1-5, and the labeling system software 1-6. Other firmware or software may also reside in the memory 1-3. In addition, the memory is used as a temporary buffer area for data of the duplication and labeling processes.

The storage device driver 1-4 is a software used by other software or firmware to access the storage devices such as a hard drive 1-9 or an optical disc drive 1-10. The storage device driver interprets the access requests and converts them to a series of commands and input/output (I/O) actions that the storage devices understand. Typical access requests include retrieving status information of the storage device, reading data from the storage device, and writing data to the storage device. Therefore the storage device driver enables the control of hard drive 1-9 and optical disc drive 1-10.

The duplication system software 1-5 controls the optical disc duplication process. It gathers information of the system, storage devices, and the optical discs. The information is used to calculate the duplication parameters for the storage devices. The duplication system software 1-5 further monitors the data flow during the duplication. Essentially, it dynamically adjusts the read and write operations to achieve the best duplication performance.

The labeling system software 1-6 controls the optical disc labeling process. Basically it shares the same information with the duplication system software 1-5. The information along with the label symbol data are used to generate labeling parameters. Like the duplication system software 1-5, the labeling system software 1-6 monitors the data flow during the labeling process and makes necessary adjustments to achieve high labeling performance.

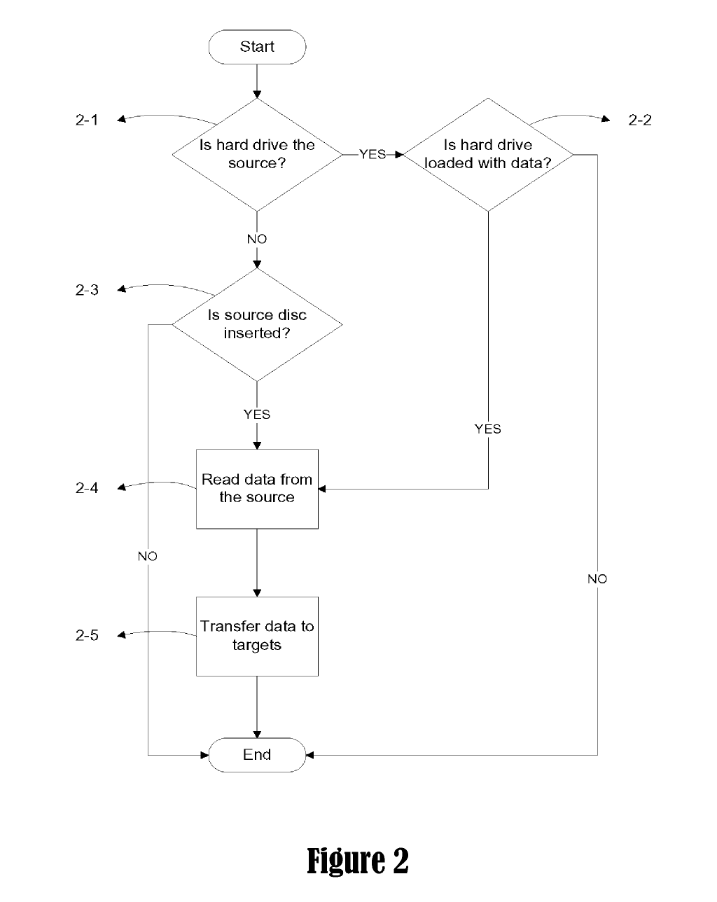

FIG. 2 is a flowchart of the duplication process. In step 2-1, the process determines if the hard drive is the source where data comes from in an optional hard drive 1-9 when said hard drive is installed. If the optional hard drive is not installed, the process proceeds to step 2-3; otherwise it proceeds to step 2-2.

In step 2-2, the process looks for valid master data for the duplication. The hard drive may contain valid master data by a beforehand loading process, which transfers the data from a master optical disc to the hard drive. The hard drive may have multiple set of master data each from a different master optical disc. The master data to be duplicated depends on the end user's instruction. If the hard drive contains the desired master data, the process proceeds to step 2-4; otherwise it terminates.

In step 2-3, the process checks if a source optical disc is inserted into the source optical drive. The source optical drive may be any one among all optical drives installed on the system instead of a dedicated one. If the source disc is detected, the process proceeds to step 2-4; otherwise it exits.

In step 2-4, the duplication system software 1-5 reads data from the source drive and stores in the memory 1-3. This includes making a read request specifying the starting address and the length of data to be read. The request is translated by the storage device driver 1-4 and passed to the source drive. The source drive may then access the medium inside to retrieve the data requested. The data is received by the duplication system software and moved to the memory 1-3.

In step 2-5, the duplication system software 1-5 transfers the data just read in to the target optical drive. This includes making a write request specifying the starting address and the length of data to be transferred. The request is translated by the storage device driver 1-4 and passed to the target drive, which may accept the data and burn on the data side of the blank optical disc.

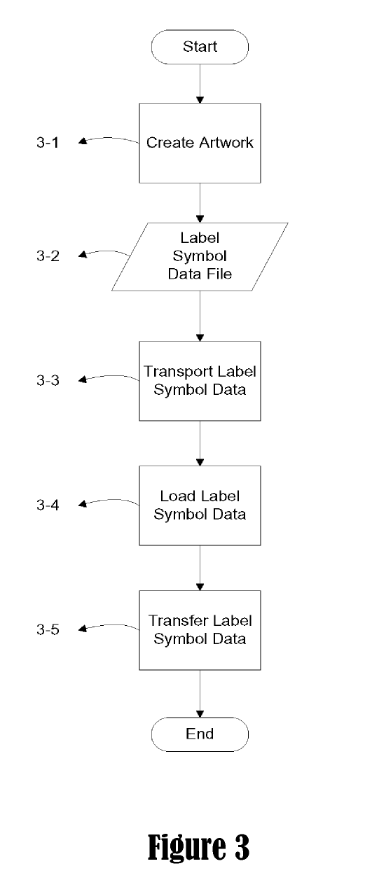

FIG. 3 is a flowchart of the labeling process according to one embodiment of the invention. In step 3-1, the end user creates a label artwork file on the PC. The end user may use any software capable of drawing to design the artwork, and save the artwork to a file of any common image format such as JPEG, GIF, BMP to name a few.

The artwork is not limited to pure text. It may include graphics or even photos mixed with text to form a complex label. For example, the artwork may have a disc name and several thumbnails of photos.

The image file is then converted to a label symbol data file 3-2 in order to be transported to the system in FIG. 1. The design software may perform the conversion seamlessly and save the artwork directly as a label symbol data file, which contains specific information to form symbols on the surface of the optical disc instead of display on the screen of a PC. This process may require proprietary information from the labeling technology providers.

In step 3-3, the label symbol data file is transported to the system in FIG. 1. The transportation requires a removable media since there is no connection between the PC and the invented system. As a result, the label symbol data file may be burnt to an optical disc, and said optical disc is carried to the invented system.

In step 3-4, the label symbol data is loaded into the memory 1-3. The optical disc containing the label symbol data file is inserted into an optical drive of the system, and the labeling system software 1-6 starts the labeling process by making read requests to said optical drive in order to retrieve the label symbol data.

In step 3-5, the labeling system software 1-6 transfers the label symbol data from the memory 1-3 to the target optical drive, which emits laser to form symbols according to the label symbol data. Transferring label symbol data may require proprietary knowledge from the labeling technology providers.

The invention provides an innovative solution for duplication and labeling with several benefits. The end user acquires a single standalone system which is able to perform both duplication and labeling. Initial setup cost is reduced, and a single system provides consistent operation experience and simplifies maintenance. The labeling requires only the disc supporting direct laser labeling with no additional materials. Therefore there is no ink or toner to replace. In addition, the productivity of labeling assumes the maximum capacity of the invented system, which other labeling or printing systems are difficult to achieve. The combined duplication and labeling throughput will increase tremendously.

The invention claimed is:

1. An integrated standalone optical disc duplication and laser labeling system comprising:
a set of optical disc drives;
a screen display unit;
a keypad unit;
a central controller having a memory, a processor running dedicated software, said controller communicating with said optical disc drives via PATA/SATA with Packet Interface standards, whereby data duplication process is first performed by and then labeling process performed.

2. The system of claim 1, wherein a storage device driver made up by firmware or software and resides in said memory enables the control of said optical disc drives by interprets the access requests and converts said requests to a series of commands and I/O actions.

3. The system of claim 2, wherein said each of said optical disc drive includes a laser head and is capable of reading data from the optical disc, burning data to the optical disc, and forming labels on the optical disc including a thermally-sensitive layer by a laser beam emitted from said laser head, in accordance with the access requests given to said storage device driver.

4. The system of claim 3, wherein a duplication system software is used to store valid master data in said memory to control the duplication process and a labeling software is used to store label data symbol in same memory to control the labeling process.

5. The system of claim 4, wherein a hard drive disc can be installed as an additional storage medium, using the same PATA/SATA with Packet Interface standards.

6. The method of direct labeling to optical disc within the same duplication system as described herein, wherein said optical disc laser labeling comprises steps of:
a. transporting pre-defined label symbol data from an external source to said system;
b. loading label symbol data into the memory; and,
c. transferring label symbol data from said memory to the optical disc drive to form label images on the label side of the optical disc inserted in said optical disc drive.

7. The method of claim 6, wherein the external source is a host PC.

8. The method of claim 6, wherein said pre-defined label symbol data is a file directly describing a label artwork created by the end user on an independent PC.

9. The method of claim 6, wherein pre-defined label symbol data is transported through external memory storage devices by first saving pre-defined label symbol data into an external memory storage means, and connecting said external memory storage means to the system of claim 1.
